(19) United States
(12) Patent Application Publication
(10) Pub. No.: US 2012/0055439 A1
(43) Pub. Date: Mar. 8, 2012

(54) PISTON WITH DEPRESSION

(76) Inventor: Ruediger HERDIN, Vignna (AT)

(21) Appl. No.: 13/219,082

(22) Filed: Aug. 26, 2011

Related U.S. Application Data
(63) Continuation of application No. PCT/EP2010/052515, filed on Feb. 26, 2010.

(30) Foreign Application Priority Data
Feb. 26, 2009 (DE) DE 102009010729.0

(51) Int. Cl. F02F 3/00

(52) U.S. Cl. 123/193.6

(57) ABSTRACT

A piston for an internal combustion engine is provided. The piston has a surface on the combustion side, wherein a depression having a depression edge and a depression floor is arranged in the surface and the depression has a maximum depth of tₘₐₓ in an axial direction of the piston, measured from the combustion side surface. The combustion side surface furthermore has at least one protrusion that is arranged on a section of the depression edge and has a depth tₐᵤₛ, wherein the depth tₐᵤₛ of the protrusion is smaller than the depth of the depression tₘₐₓ in the axial direction of the piston.

This nonprovisional application is a continuation of International Application No. PCT/EP2010/052515, which was filed on Feb. 26, 2010, and which claims priority to German Patent Application No. DE 10 2009 010 729.0, which was filed in Germany on Feb. 26, 2009, and which are both herein incorporated by reference.

### BACKGROUND OF THE INVENTION

1. Field of the Invention

The present invention relates to a piston for an internal combustion engine. In particular, the invention relates to the embodiment of a combustion chamber-side surface of the piston, which has a depression and one or more protrusions.

2. Description of the Background Art

In internal combustion engines, pistons are used in order to bring about the necessary compression of air or of a fuel-air mixture. In the case of air compression, the fuel is then injected into the combustion chamber. In the combustion chamber there is then a mixture of fuel and air, which ignites after the predetermined compression. This can be spark ignition, e.g., by a spark plug, as well as compression ignition.

It is particularly important thereby that the combustion runs in an optimum manner, i.e., with a high efficiency, low consumption and without harmful side effects, such as, e.g., knocking or self-ignition. A sudden steep rise in pressure is the result, and leads to high mechanical stress. Due to these side effects, e.g., the engine can be damaged and its service life reduced. It is therefore important that a defined combustion takes place.

Parameters for controlled combustion are, among other things, the combustion temperature, the compression, the duration of the combustion and the smooth course of the combustion. These parameters, and thus also the knocking or self-ignition properties, can be influenced by various techniques, e.g. by enriching the fuel supply, by an antiknock fuel or by the injection of cooling substances. Nevertheless, it is desirable to further increase the efficiency as well as the quality of the processes in the combustion chamber, in order, e.g., to promote economical fuel consumption or to protect the engine from damage and sustained damage.

### SUMMARY OF THE INVENTION

It is an object of the invention to further develop a piston such that it overcomes the disadvantages of the prior art, in particular makes the combustion in a combustion chamber of a piston more efficient, accelerates the combustion process and homogenizes the fuel-air mixture before combustion.

The object is attained according to an embodiment of the invention by a piston for an internal combustion engine with a combustion chamber-side surface, wherein a depression with a depression edge and a depression floor is arranged in the surface, wherein the depression has a maximum depth tₘₐₓ measured in the axial direction of the piston from the combustion chamber-side tₐᵤₛ, surface, and wherein at least one protrusion extends from a section of the depression rim and has a depth tₐᵤₛ, wherein the depth tₐᵤₛ the protrusion in the axial direction of the piston is smaller than the depth of the depression tₘₐₓ.

In an embodiment, at least two protrusions can be arranged in the combustion chamber-side surface.

According to a further embodiment, at least three protrusions can be arranged in the combustion chamber-side surface.

In a further embodiment of the present invention, the depth of the at least one protrusion tₐᵤₛ can be between 30% and 70%, in particular between 40% and 60%, preferably between 45% and 55% of the depth tₘₐₓ of the depression.

A further embodiment of the present invention shows an essentially circular depression rim in the combustion chamber-side surface.

According to an aspect of the present invention, the depression can be embodied essentially concentrically to the outer rim of the combustion chamber-side surface.

According to another aspect, the depression can be embodied essentially eccentrically to the outer rim of the combustion chamber-side surface.

In a further embodiment, the piston can have at least one first acceleration edge for the proportion of the squish flow between the combustion chamber-side surface and the at least one protrusion and at least one second acceleration edge between the at least one protrusion and the depression. The squish flow thereby designates the flow from the piston surface to the protrusion, or to the depression shortly before reaching the upper dead-center position.

In an embodiment, the depression floor can be embodied such that it is less deep in the radial direction towards the center of the depression floor than in the radial direction towards the outer depression rim.

According to a further aspect of the present invention, the depression floor has an essentially conical region.

In a further embodiment, the essentially conical region of the depression can be arranged essentially concentrically to the depression.

According to an embodiment, the piston can have a piston skirt, which comprises an ring groove, which is designed to accommodate a ring carrier for a piston ring. In this embodiment, the at least one protrusion is thereby delimited by the ring groove in the radial direction.

In an embodiment, the protrusion, in particular the rim of the protrusion, can be arranged at a distance of at least 1 mm from the ring carrier.

One embodiment of the present invention provides a design of the at least one protrusion such that the shape of the at least one protrusion is essentially in the shape of a circle segment.

According to one aspect of the present invention, the piston can be used in an internal combustion engine, which is a gas engine.

According to a further aspect, the internal combustion engine can be a compression-ignition engine.

One embodiment of the present invention is designed such that the ratio between the sum of all sections of the depression rim from which a protrusion extends and the entire depression rim is between 30% and 70%, in particular between 40% and 60%, preferably between 45% and 55%.

Another embodiment represents the ratio between one section of the depression rim from which a protrusion extends and the total depression rim. The ratio accordingly can be between 10% and 70%, in particular between 15% and 50%, preferably between 20% and 30%.

The invention is thus based on the finding that the embodiment according to the invention of the combustion chamber-side surface of the piston both promotes a rapid combustion of the fuel-air mixture and prevents knocking and thus supports a maximum energy yield. Furthermore, the high degree of turbulence of the mixture caused by the design of the combustion chamber-side surface is advantageous in order to increase the blending of the individual components, that is, in particular of air and fuel, immediately before the combustion. A homogenous blending of air and fuel in the entire combustion chamber thereby helps to cause the combustion to take place uniformly over the combustion chamber and quickly.

In particular one or more acceleration edges in the combustion chamber-side surface of the piston render possible a good blending of the air-fuel mixture. Through the acceleration edges, the distribution (homogeneity) of the fuel-air mixture over the entire combustion chamber is improved so that no over-concentrations or under-concentrations of the mixture occur in the combustion chamber. This ensures that the combustion runs in a very controlled manner in the combustion chamber. The fuel-air mixture flows over the acceleration edges, whereby different speeds of the fuel are achieved on the combustion chamber-side surface. This means that the turbulence in the combustion chamber is markedly increased and a better blending of the fuel with the air is achieved.

Another aspect of the present invention is provided by the above-referenced effects, such as homogenous distribution of the fuel-air mixture and increased degree of turbulence, directly before ignition. The faster combustion also permits a higher compression, a higher efficiency is achieved compared to known embodiments of piston depressions and thus the energy yield is ever further optimized.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a is a diagrammatic side view of a piston;

FIG. 1b is an enlarged view of a cross section of a piston ring groove;

FIG. 1c is an enlarged view of a cross section of a piston ring groove with ring carrier;

FIG. 2 is a plan view of a combustion chamber-side piston surface according to an embodiment of the present invention;

FIG. 3 is a diagrammatic sectional view of the piston from FIG. 2;

FIG. 4 is a plan view of a combustion chamber-side piston surface according to further embodiments of the present invention;

FIG. 5 is a plan view of a further combustion chamber-side piston surface according to embodiments of the present invention;

FIG. 6a is a plan view of a combustion chamber-side piston surface according to further embodiments of the present invention;

FIG. 6b is an enlarged view of a section from FIG. 6a:

FIG. 7 is a plan view of a combustion-chamber side piston surface according to another embodiment of the present invention

FIG. 8a is a plan view of a combustion chamber-side piston surface according to further embodiments of the present invention;

FIG. 8b an enlarged sectional view of the combustion chamber-side piston surface according to FIG. 8a;

FIG. 9 shows a diagrammatic perspective view of a combustion chamber-side part of a piston according to further embodiments of the invention;

FIG. 10 shows a diagrammatic view of a piston with tilted protrusions according to further embodiments of the invention;

FIG. 11 shows a projection to illustrate the tilt of the protrusions according to still further embodiments of the invention; and

FIG. 12 is a plan view of a combustion chamber-side piston surface according to further embodiments of the present invention.

### DETAILED DESCRIPTION

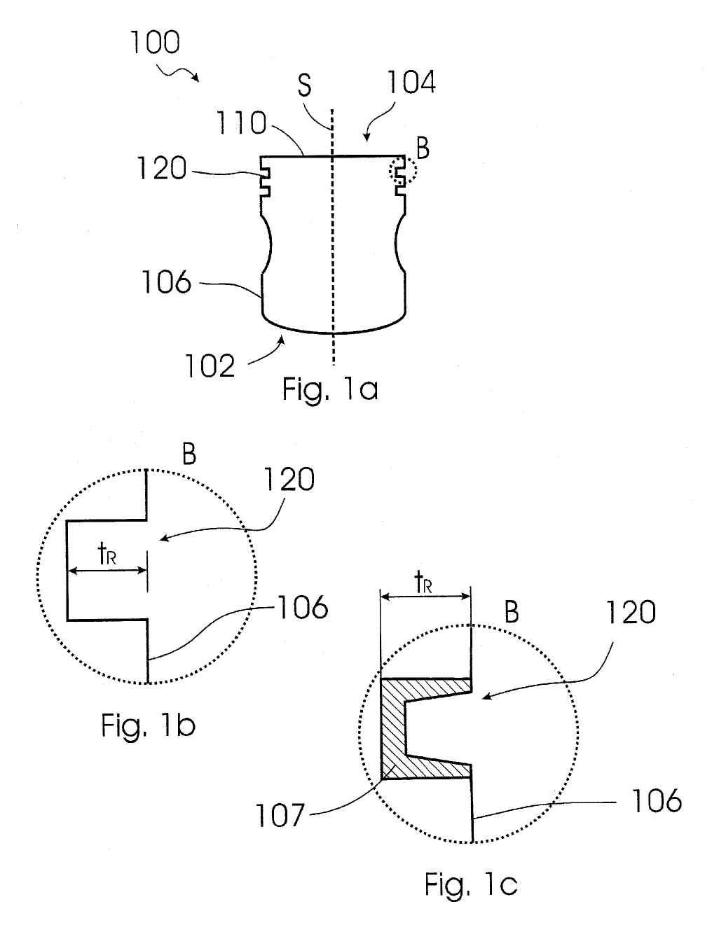

FIG. 1a shows a diagrammatic side view of a piston 100 for an internal combustion engine. The piston 100 is designed to be used in a cylinder of an internal combustion engine. The piston 100 is shaped in an essentially cylindrical manner with an axial axis S and has a first end 102, to which, for example, a piston rod can be attached, and a second end 104, which faces towards the combustion chamber of the cylinder and on which a combustion chamber-side surface 110 is arranged. The piston further comprises a skirt 106 between the first and the second end 102, 104 of the piston. In one embodiment of the piston, one or more peripheral ring grooves 120 are arranged in the skirt 102 of the piston 100, which ring grooves are designed to receive piston rings in the assembled state. The ring grooves, e.g., for reasons of strength, can be reinforced with an additional material, for example, with a ringer carrier, the material of which differs from the material of the piston itself. For example, the piston ring grooves can be reinforced with a material such as gray cast iron, for example, or ceramic fiber reinforcements.

FIG. 1b shows an enlarged section B from FIG. 1a of a ring groove 120. The ring groove 120 has depth t_{R} in the radial direction from the skirt 106. In the assembled state piston rings are inserted into the ring grooves or into the ring carriers, which piston rings are used for sealing, for metering the lubricating oil and for dissipating the combustion heat.

FIG. 1c shows a different embodiment of section B from FIG. 1a. A ring carrier 107 is arranged in the ring groove 120, which ring carrier can be made of a reinforcing material and which is designed to accommodate a piston ring. In the event that a ring carrier 107 is present in the ring groove 120, the depth t_{R} refers to the depth of the ring carrier 107 inwards in the radial direction, as can be seen in FIG. 1c.

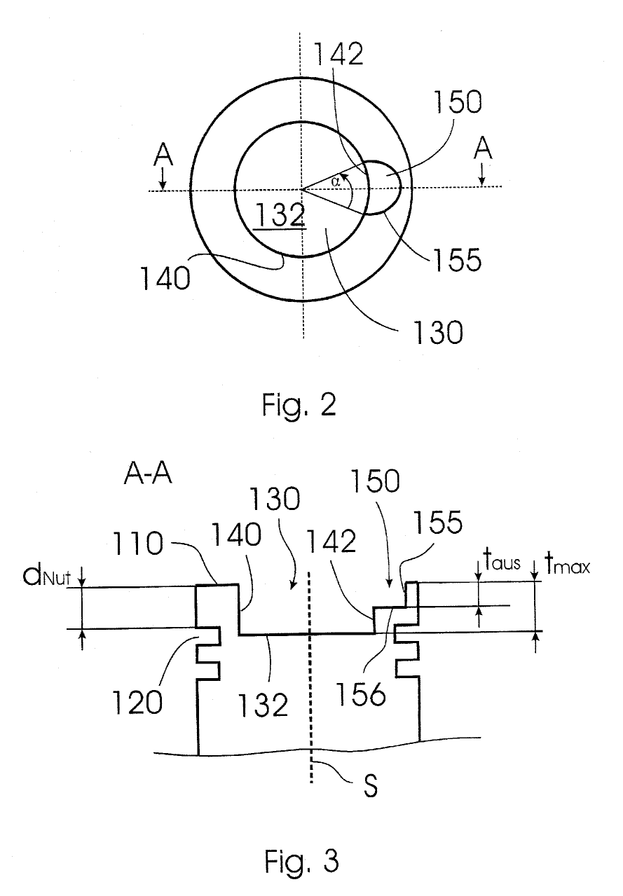

FIG. 2 shows a diagrammatic plan view of the combustion chamber-side surface 110. The surface 110 thereby has a depression 130 with a depression rim 140 and a protrusion 150, with a protrusion rim 155, extending from the depression rim. The edge of the protrusion rim 155 can also be referred to as an acceleration edge. The protrusion 150 is arranged in a section 142 of the depression rim 140. In one embodiment, the protrusion 150 can have the shape of an ellipse section.

One section of a depression rim in this context is to be understood as a part or a partial region of the depression rim. If the depression rim is circular, for example, the section 142 can be a circular arch with any angle α. However, a section can also be defined via a portion of the circumference of the depression rim. For example, if the depression is elliptical, a protrusion can, for example, adjoin 25% of the depression rim which corresponds to the circumference of the ellipse.

According to embodiments of the present invention, which can be combined with other embodiments, the shape of the protrusion can be essentially preferably circular, circle segment-shaped, or elliptical, or have any other shape.

Typically, the depression shape can vary depending on the field of application and use of the corresponding piston. In FIG. 2 the depression 130 is circular, for example, but it can also be essentially elliptical or have any other shape.

FIG. 3 shows the cross section A-A of the piston 100 from FIG. 2. The depression 130 comprises a depression floor 132, wherein the depression floor 132 has a depth tₘₐₓ with respect to the combustion chamber-side surface 110. The protrusion 150 with the protrusion floor 156, which extends from the depression rim 140, in particular from a section 142 of the depression rim 140, in contrast has a smaller depth tₐᵤₛ with respect to the combustion chamber-side surface.

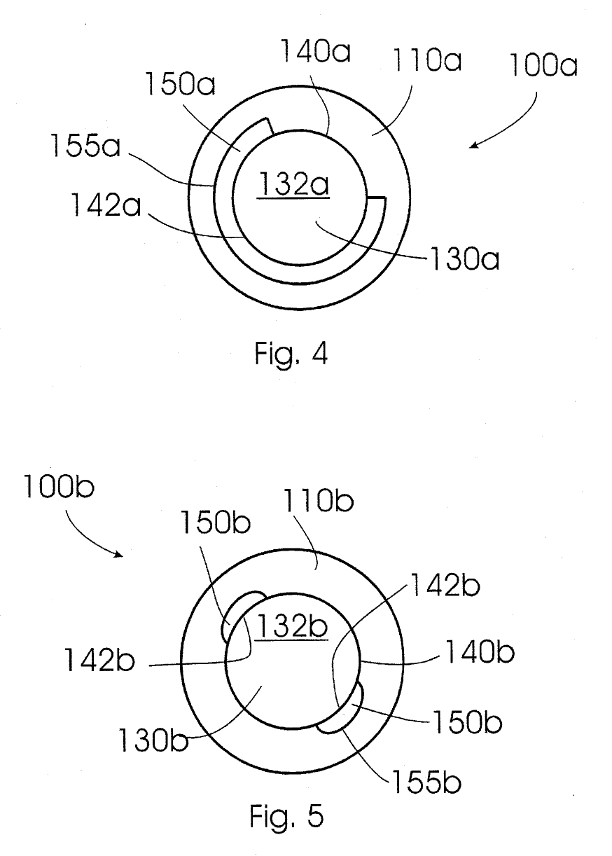

In FIG. 4 another embodiment of the present invention is shown in a diagrammatic plan view of a combustion chamber-side surface 110a with an essentially circular depression 130a with depression floor 132a. A protrusion 150a with a protrusion rim 155a is arranged on a section 142a of the depression rim 140a. It is clear compared to FIG. 2 that the section 142a of the depression rim 140, from which the protrusion 150a extends, has a larger circular arch segment, in terms of percentage as well as in absolute terms, than the section in the embodiment shown in FIG. 2.

FIG. 5 shows the diagrammatic plan view of a combustion chamber-side surface 110b of a piston 100b according to further embodiments of the present invention. The combustion chamber-side surface 110a has an essentially circular depression 130b with a depression rim 140b, from which two protrusions 150b with an essentially identical shape and size extend. The protrusions 150b have in each case a protrusion rim 155b. In FIG. 5 the protrusions extend from sections 142b of the depression rim 140b lying essentially opposite one another.

In FIG. 5 two protrusions 150b are distributed uniformly over the depression rim 140b of the depression 130b. In other embodiments of the present invention, the protrusions 150b can also be distributed irregularly over the depression rim 140b.

In some embodiments of the present invention which can be combined with other embodiments, with a plurality of protrusions, the individual protrusions have a different shape. For example, the different protrusions can vary in size, but have essentially the same geometry. According to other embodiments, the size of the individual protrusions is identical or at least similar, but the geometry differs.

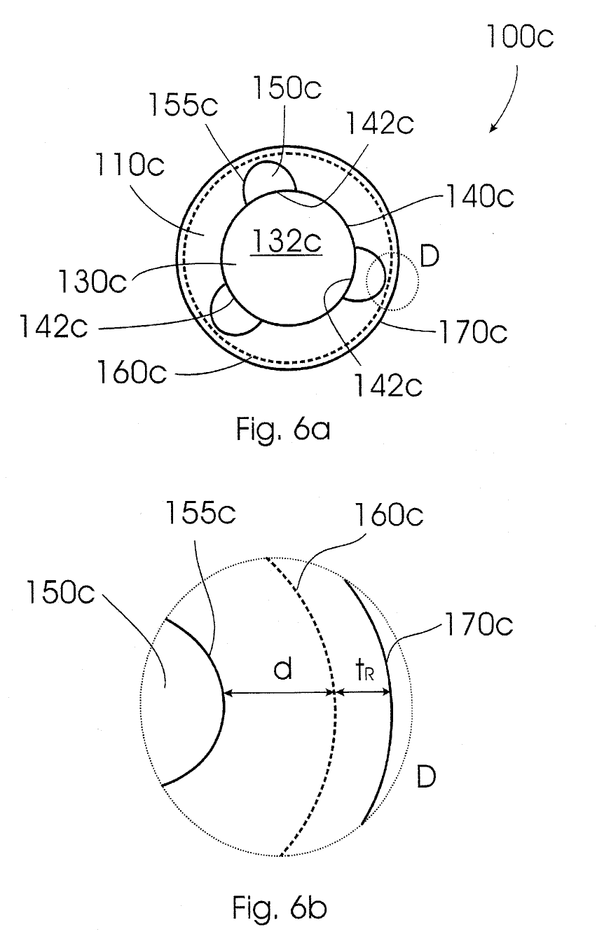

FIG. 6a shows a further embodiment of a piston 100c, which has an essentially circular depression 130c with a depression rim 140c and three protrusions 150c extending from sections 142c of the depression rim 140c on a combustion chamber-side surface 110c of the piston 100c. Furthermore, in FIG. 5a an inner circle 160c of a ring groove 120c can be seen by the dashed line, as it is shown, for example in FIG. 1a. FIG. 6b shows a detailed view of section D from FIG. 6a. FIG. 6b shows the depth t_{R} of a ring groove as distance of the inner circle 160c from the outer rim 170c of the combustion chamber-side surface 110c, wherein the outer rim 170c essentially corresponds to the skirt 106 of the piston 110c.

According to further embodiments, in the case of a piston with ring carrier 107 (such as, e.g., shown in FIG. 1c), the depth t_{R} can designate the depth of the ring carrier in the radial direction. In such a case, the theoretical inner circle 160c is the rear edge of the ring carrier 107 in the radial direction.

In one embodiment, the ring groove 120c is arranged at a distance d_{Nut} (see FIG. 3) from the combustion chamber-side surface 110c of the piston 100c, wherein the distance is the same as or less than the depth tₐᵤₛ of the recess. Consequently, the protrusion 150c is limited by the inner circle 160c of the ring grooves in the radial direction towards the outer rim 170c. For example, in the detailed view of FIG. 6b, there is a distance d between the protrusion rim 155c and the inner circle 160c. This distance d can depending on the diameter of the combustion chamber-side surface 110c, the geometry of the protrusion 150c, the depth of the ring groove t_{R}, the depth of the ring carrier t_{R} or the material with which the ring groove is reinforced.

In other words, the protrusion or the protrusions 150c are designed such that they do not influence the strength and the functionality of the ring groove and/or of the ring carrier. For example, with an overlap of the protrusion rim 155c of the protrusions 150 and the inner circle 160c of the ring groove or of the ring carrier 107, the geometry or the material of the ring groove or of the ring carrier 107 can be damaged so that the service life of the piston is shortened. Through a suitably selected distance d, damage is prevented and the functionality of the ring groove and/or of the ring carrier is further guaranteed.

It has been shown thereby that the largest possible extension of the protrusions in the radial direction is advantageous. That is, the distance d should be as small as possible because of the functionality of the protrusion 150, but large enough to avoid damage to the ring groove, or the ring carrier material.

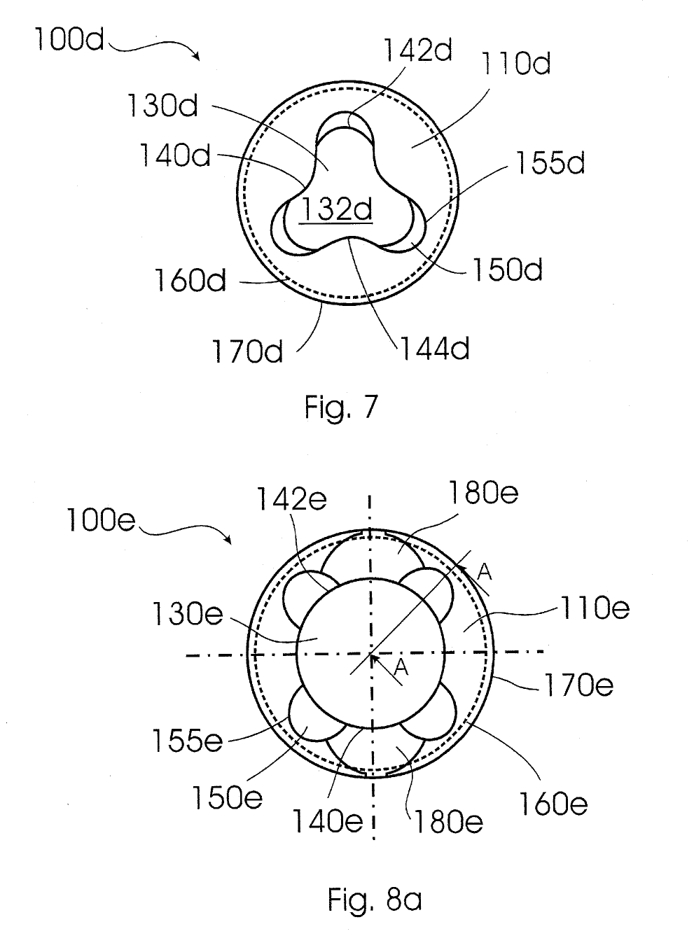

FIG. 7 shows the diagrammatic plan view of a combustion chamber-side surface 110d of a piston 100d according to a further embodiment. The depression 130c has a wave-shaped depression rim 140c, wherein the wave shape is superimposed on a circular shape. The depression rim 140c, for example, has three wave peaks 142d and three wave valleys 144d. In this embodiment, three protrusions 150d with a protrusion rim 155d are oriented to the geometry of the depression 130d or of the depression rim 140d, so that the protrusions 150d, i.e., the shape of the protrusion rims 155d, is adapted from the shape of the depression rim 140d, and they extend radially outwards from the wave peaks 142d. However, according to other embodiments, the protrusions 150d can also be arranged contrary to the geometry of the depression rim 130d, i.e., a protrusion 150d can be arranged at a point at which the depression 130d or the depression rim 140d has an indentation or a wave valley 144d.

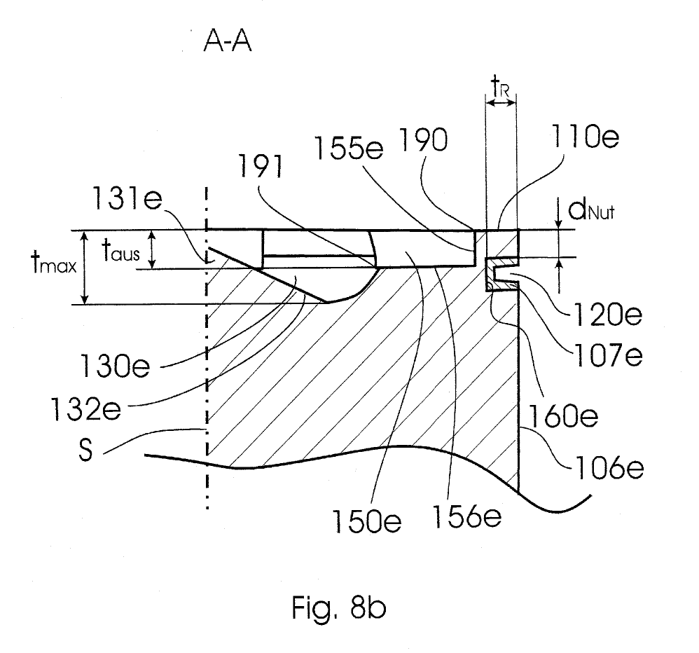

FIG. 8a shows a diagrammatic plan view of the combustion chamber-side surface 110e of a further embodiment of a piston 100e of the present invention. The combustion chamber-side surface 110e has an essentially circular depression 130e, which is embodied concentrically to the outer rim 170e of the combustion chamber-side surface or to the skirt 106e of the piston. Furthermore, the embodiment from FIG. 8a shows 4 protrusions 150e with respectively one protrusion rim 155e, which extend from the depression rim 140e, in particular from sections 142e of the depression rim, radially outwards. In addition two, in particular flat, pockets 180e to accommodate the valves projecting into the combustion chamber are shown by way of example. In the event of a 4 valve cylinder head, naturally 4 such clearances must be available.

The term “flat” here designates a depth that is less than the depth of the protrusions tₐᵤₛ. For example, the depth of the pockets 180e can be only 10% or 20% of the depth of the protrusions.

As already shown in 6a and 6b, FIG. 8a shows the inner circle 160e of a ring groove 120e. In one embodiment with ring carrier, the inner circle 160e designates the rear edge of a ring carrier 107e in the radial direction inwards.

FIG. 8b shows the enlarged section A-A from FIG. 8a. The depression 130e has a depression floor 132e, which at the rim merges into the depression rim 140e. The protrusion 150e then extends from the depression rim 140e. A ring groove 120e with a ringer carrier 107e is made by way of example in the skirt 106e of the piston 100e.

According to one embodiment of the present invention, the protrusion 150e has a depth tₐᵤₛ in the axial direction of the piston 100e with respect to the combustion chamber-side surface 110e and the depression has a maximum depth tₘₐₓ likewise in the axial direction of the piston 100e. The depths tₐᵤₛ and tₘₐₓ can be measured in each case from the combustion chamber-side surface 110e. The depth tₐᵤₛ of the protrusion 150e is smaller than the maximum aus depth tₘₐₓ of the depression.

According to some embodiments of the present invention, which can be combined with other embodiments, the depth tₐᵤₛ of the protrusion 150 is between 30% and 70%, in particular between 40% and 60% and preferably between 45% and 55% of the depth tₘₐₓ of the depression in the axial direction of the piston.

A first acceleration edge 190 is formed between the surface 110e and the protrusion 150e or the protrusion rim 155e, and a second acceleration edge is formed between a protrusion floor 156e and the depression rim 140e. Consequently, two acceleration edges 190, 191 are produced through the ratio of the depth of the protrusion 150e to the depth of the depression 130e. During the injection, a fuel or a fuel mixture flows over the acceleration edges 190, 191. The fuel is thereby accelerated by the geometry expansion of the protrusion 150e. This accelerates the injection process and ensures a quick combustion.

Since the protrusions 150e lie in some sections on the depression rim, different speeds occur in the sections of the depression in the combustion chamber-side surface, to which a protrusion adjoins compared to the sections of the depression rim to which no protrusion adjoins, also referred to as “webs.” The different speeds in the combustion chamber at points with protrusion and at points at which webs are located, increases the turbulence in the combustion chamber and thus leads to a better blending of the fuel or the fuel mixture with the air in the combustion chamber before combustion.

The increased turbulence renders possible a better compression compared to combustion chamber-side surfaces without protrusions according to embodiments of the present invention and thus causes a quicker, more efficient and homogeneous combustion.

Typically, the acceleration edges 190, 191 or at least the acceleration edge 191 at the transition from one depth plane to another have a sharp-edged geometry. In the example of the acceleration edge 191, that is the transition from the combustion chamber-side surface 110e to the protrusion rim 155e. The term “sharp-edged” hereby relates to a geometry that essentially is not rounded. In this context, a rounding up to 0.3 mm is still referred to as “sharp edged.”

Through sharp-edged acceleration edges the above effects such as intensified acceleration and increase of turbulence are additionally intensified. The edges are typically rounded with a radius between 0.1 mm and 0.3 mm in order to prevent damage to the edges by the high temperatures in the combustion chamber. An edge that is not rounded would begin to anneal at the temperatures during the combustion process and possibly trigger ignitions that could prematurely ignite the fuel or the fuel mixture and thus reduce efficiency.

According to further embodiments, the design of the protrusion 150e can be as in section A-A, i.e., with a flat protrusion floor 156e. According to other embodiments, the protrusion floor 156e can also have a specific profile. This profile can contain, e.g., one or more circular arch segments, steps, further acceleration edges, further protrusions and the like. If the floor 156e of the protrusion 150e is profiled, the depth tₐᵤₛ defined by the maximum depth of the protrusion 150e in the axial direction.

The depression floor 132 e can also be flat or profiled, In the embodiment of the invention that is shown in FIG. 8b, the depression floor 132 has an internal taper 131e, which is preferably embodied symmetrically to the axis S.

According to further embodiments of the present invention, which can be combined with other embodiments, the depression 130e in the center, in particular towards the symmetry axis S, has a region that has a smaller depth than the maximum depth tₘₐₓ of the depression. In other words, the depression is flatter towards the center of the piston than towards the outer depression rim 140e. For example, as shown in FIG. 8b, the depression 130e can be conical in the center, but it can also have the shape of a flattened or rounded cone. According to further embodiments, the depression 130e can also have a spherical segment-shaped flattening towards the center. According to another aspect of the present invention, the profile of the depression 130e can also have one or more circle segments, steps or acceleration edges.

Further advantages of the embodiments of the present invention can result with respect to the swirl of the fuel air mixture. For example, with 4 valve cylinder heads of modern design, the inlet swirl is kept moderate. The nozzle injection geometry can be optimized to 7 to 9 orifice-type injectors to improve the mixture formation. Typically, a swirl is hereby produced in conventional manner through the inlet conduits i.e. through so-called tangential and spiral ducts. A typical swirl number with this design can be 1.3 to 1.6. With the conversion of this design to a gasoline engine with direct ignition, however, the problem can arise that the flame propagation in the circumferential direction of the piston is too low and thus the combustion runs more slowly than desired.

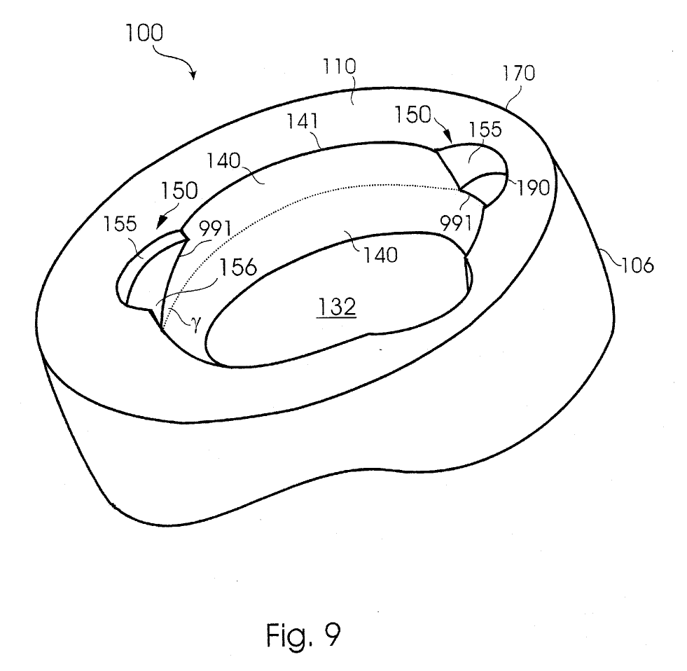

Therefore according to further embodiments of the invention, which can be combined with other embodiments described herein, the circumferential speed of the flow around the combustion chamber can be increased through the design of the combustion chamber. To this end, according to these embodiments the protrusion or the protrusions are tilted or tipped. FIG. 9 shows a section from a piston 100 embodied in this manner and illustrates a tilting of the protrusion which can be separate or combined with the other embodiments of the invention.

FIG. 9 shows a diagrammatic perspective view of a combustion chamber-side section of a piston 100. This has a combustion-side surface 110. The combustion chamber-side surface contains an essentially circular depression, which in FIG. 9 by way of example is embodied concentrically to the outer rim 170 of the combustion chamber-side surface or to the skirt 106 of the piston. Furthermore, FIG. 9 shows three protrusions 150 with in each case a protrusion rim 155 and a protrusion floor 156, which extend radially outwards from the depression rim 140, in particular from sections 142 (see FIG. 11) of the depression rim.

According to typical embodiments, the depression has a depression floor 132, which merges into the depression rim 140 at the rim. The depression floor can be embodied according to one of the embodiments described above. In combination with the tilted protrusions shown in FIG. 9, in particular a depression floor 132 with an internal taper arranged in an inner region is advantageous, as is shown, for example, in FIG. 8. The protrusion 150 then extends from the depression rim 140.

As shown in FIG. 9, in regions without protrusion, the depression rim extends to the web, i.e., the edge 141 into the combustion chamber-side surface 110. In regions with protrusion 150 (see reference number 142 in FIG. 11), the depression rim 140 merges at the acceleration edge 991 into the protrusion floor 156, which in turn opens into the protrusion rim 155. The protrusion rim with the combustion chamber-side surface 110 forms the further acceleration edge 190.

According to some embodiments of the invention, the acceleration edge 991 or the protrusion floor 156 is tilted. This is indicated in FIG. 9 by the angle γ which is drawn between the acceleration edge 991 and the dotted reference line that illustrates a plane perpendicular to the piston axis of the greatest depth of the protrusion floor 156. With respect to the acceleration edge 991, the angle γ results from any tangent on the acceleration edge 991 and the plane spanned by dotted reference line, i.e., a plane perpendicular to the piston axis. Analogously, the angle γ results from the section of this plane with the plane formed by the protrusion floor 156.

Further alternative embodiments can be embodied in that in the case of a piston with 2 or more protrusions, the tilt angle γ is identical for all protrusions. Alternatively thereto, the tilt angle or the inclination angle of the protrusions can be varied for individual protrusions or for groups of protrusions in order to improve the control of the swirl or the circumferential speed of the flow. A variation of this type can correlate, i.a., with a position of a protrusion corresponding to a spark plug position.

In particular with reference to the piston angle coordinates relative to a spark plug position in the engine, different embodiments can also be embodied as follows. On the one hand—as shown in FIG. 9, the three protrusions 150 can be uniformly distributed over the depression rim 140 of the depression or the webs 141 can have the same length between the respective protrusions. On the other hand, in other embodiments of the present invention, the protrusions 150 can also be irregularly distributed over the depression rim 140. An irregularly distribution, i.e., varying web lengths, can lead, e.g., to an improvement in the flow conditions in the region of the spark plug. For example, with 3, 4 or 5 protrusions or recesses in the combustion chamber, the protrusions or recesses can be arranged at a shorter distance (narrow webs) and a much greater distance (broader web), for example, a web with a length at least 50% greater compared to the narrow webs, can be embodied between the fourth and first protrusion.

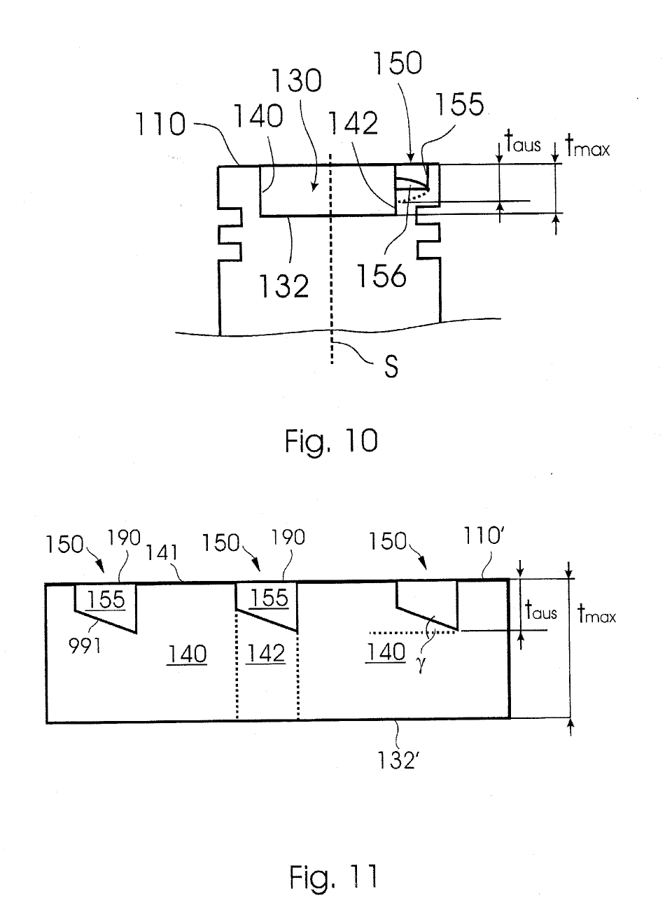

As shown in FIG. 10, the protrusion 150 has a maximum depth t in the axial direction of the piston 100 relative to the combustion chamber-side surface 110, and the depression has a maximum depth tₘₐₓ likewise in the axial direction of the piston 100. The depths tₐᵤₛ and tₘₐₓ can in each case be measured from the combustion chamber-side surface 110. The maximum depth tₐᵤₛ of the protrusion 150 is smaller than the maximum depth tₘₐₓ of the depression.

According to some embodiments of the present invention, which can be combined with other embodiments, the depth tₐᵤₛ of the protrusion 150 is between 30% and 70%, preferably between 40% and 60% and preferably between 45% and 55% of the depth tₘₐₓ of the depression in the axial direction of the piston.

FIG. 10 shows furthermore a diagrammatic view of a piston embodied with tilted protrusions 150. The surface 110 has a depression 130 with a depression rim 140 and extending from the depression rim a protrusion 150 with a protrusion rim 155. The protrusion floor 156 is here shown partially visible through the tilt of the floor relative to a plane standing perpendicular to the axis S. The part of the protrusion floor not visible per se in the representation is indicated by the dotted line. According to embodiments of the present invention which can be combined with other embodiments, the shape of the protrusion can be essentially preferably circular, circle segment shaped or elliptical, or can have any other shape. As shown in FIG. 10, the depression 130 contains a depression floor 132, wherein the depression floor 132 has a depth tₘₐₓ with respect to the combustion chamber-side surface 110. The protrusion 150 with the protrusion floor 156, which extends from the depression rim 140, in particular from a section 142 of the depression rim 140, however, has a smaller depth tₐᵤₛ with respect to the combustion chamber-side surface. Thereby the smaller depth tₐᵤₛ is to be understood to be the maximum depth of the protrusion floor.

In this context, a section of a depression rim is to be understood to be a part or a partial region of the depression rim. If the depression rim is circular, for example, then section 142 can be a circular arch with any angle α. However, a section can also be defined via a portion of the circumference of the depression rim. For example, if the depression is elliptical in shape, a protrusion can adjoin, for example, 25% of the depression rim, which corresponds to the circumference of the ellipse. Typically, the depression shape can also vary, depending on the field of application and field of use of the corresponding piston. According to some of the embodiments of the invention shown here, the depression 130 is circular, for example, but it can also be essentially elliptical or have another shape.

For further clarification, FIG. 11 illustrates the tilt or inclination of the protrusions in another representation. This is a projection of the circumference from the view of the axis S in a sheet plane. The horizontal extension in FIG. 11 can thus be assigned to an angle of 0° to 360°. A first acceleration edge 190 is formed between the surface or the edge 110′ and the protrusion 150 or the protrusion rim 155, and a second acceleration edge 991 is formed between a protrusion floor and the depression rim 140/142. Consequently, through the ratio of the depth of the protrusion 150 to the depth of the depression to the depression floor or the associated edge 132′ two acceleration edges 190. 991 are formed. During the injection, a fuel or a fuel mixture flows over the acceleration edges 190, 991. The fuel is thereby accelerated by the geometry expansion of the protrusion 150. This accelerates the injection process and ensures a quick combustion. Furthermore, through the tilt of the protrusion 150, the circumferential speed of the flow of the fuel or the fuel mixture is increased. This is particularly effective when the piston moves towards the upper dead-center position before the start of the combustion.

According to typical embodiments of the invention, the angle γ, i.e. the tilt angle of the protrusion 150, can be at least 3°. In particular the inclination angle of the protrusion can be at least 4°, e.g., between 4° and 20°, in particular between 5° and 15°. Depending on the area conditions between the compression surface (squish band), the geometry of the recess, the angle of inclination and the outlet swirl, the swirl can be increased for a production of a high-turbulence combustion process. In FIG. 11 this angle is likewise shown by γ with respect to a plane (horizontal line in FIG. 11) perpendicular to the piston axis.

As can be seen in FIG. 11, the edge 991 of the protrusion rim 155, which can also be referred to as an acceleration edge, is arranged on a section 142 of the depression rim 140.

Since the protrusions 150 in some sections lie on the depression rim, different speeds occur in the sections of the depression in the combustion chamber-side surface to which a protrusion adjoins compared to the sections of the depression rim to which no protrusion adjoins, also referred to as “webs” 141. The different speeds in the combustion chamber at points with protrusion and at points at which webs are located, increases the turbulence in the combustion chamber and thus leads to a better blending of the fuel or of the fuel mixture with the air in the combustion chamber before combustion. The increased turbulence renders possible a better compression compared to combustion chamber-side surfaces without protrusions according to embodiments of the present invention and thus causes a quicker, more efficient and homogeneous combustion.

Furthermore, the tilting leads to protrusions, i.e., the floor area of the protrusions to a targeted increase of the swirl. Therefore, for example, with a direct ignition the flame propagation in the circumferential direction of the piston can also be sufficient to render possible the combustion at a desired speed.

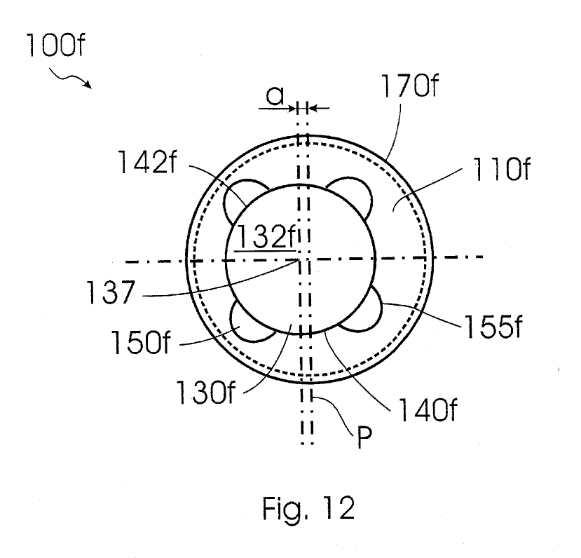

FIG. 12 shows another embodiment of the present invention. It shows, similar to FIG. 8a, a diagrammatic plan view of a combustion chamber-side surface 100f of a piston 100f. Four protrusions 150f are shown by way of example, which extend from sections 142f of the depression rim 140f. The depression 130f has an essentially circular depression rim 140f. The center of the depression 137 is not arranged on the axis P of the piston, which comprises the center of the outer edge 170f of the piston. That is, the depression is arranged asymmetrically in particular eccentrically to the axis P. The offset of the depression center 137 to the axis P of the piston 100f is marked by a distance a. Typically, the distance a has a value in the range of a few millimeters, for example, between one and five millimeters and preferably between two and three millimeters.

According to further embodiments of the present invention, the section of the depression rim 142 to which a protrusion adjoins and the depression rim 140f have a defined ratio to one another. As shown by the previous figures, this ratio can differ greatly. For example, in FIG. 4 the ratio of section 142 to the depression rim 140 can be very high at approx. 70%, or, as shown in FIG. 5, the ratio of all sections 142b of the depression rim 140b to the depression rim 140b can be relatively small at approx. 30%.

Typically, the ratio of a section of the depression rim to which a protrusion adjoins to the total depression rim is between 10% and 70%, in particular between 15% and 50% and preferably between 20% and 30%.

In the event that several protrusions are shaped, the ratio of the sum of all sections to which protrusions adjoin to the total depression rim, depending on the number of protrusions, is between 30% and 70%, in particular between 40% and 60% and preferably between 45% and 55%.

In the drawings one, two, three or four protrusions are shown by way of example. According to further embodiments of the present invention, however, the number of protrusions can also be higher than four, for example five, eight or even more than eight.

Applications for a piston with the design described above of the combustion chamber-side surface are, for example, compression-ignition engines. Typically, pistons of this type can be used in gas engines. Through the use of pistons with the geometry shown in this application with the aid of the figures, in a gas engine, for example, the compression can be increased from 11:1 to 13.5:1, compared to the compression of an engine with the known piston geometry.

The features of the invention disclosed in this specification, the claims and in the drawings can be essential individually as well as in any combination for the realization of the invention in its different embodiments.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A piston for an internal combustion engine, the piston comprising:
a combustion chamber-side surface, wherein in the surface a depression with a depression edge and a depression floor are arranged,
wherein the depression has a maximum depth tₘₐₓ measured in an axial direction of the piston from the combustion chamber-side surface,
wherein at least one protrusion extends from a section of a depression rim and has a depth tₐᵤₛ, and
wherein the depth tₐᵤₛ of the protrusion in the axial direction of the piston is smaller than the maximum depth of the depression tₘₐₓ.

2. The piston according to claim 1, wherein at least two protrusions are arranged on the piston.

3. The piston according to claim 1, wherein at least three protrusions are arranged on the piston.

4. The piston according to claim 1, wherein the depth of the at least one protrusion tₐᵤₛ reaches between 30% and 70%, between 40% and 60%, or between 45% and 55% of the depth tₘₐₓ of the depression.

5. The piston according to claim 1, wherein depression rim in the combustion chamber-side surface is essentially circular.

6. The piston according to claim 1, wherein the depression is essentially concentrically towards an outer rim of the combustion chamber-side surface.

7. The piston according to claim 1, wherein the depression is formed essentially eccentrically towards the outer rim of the combustion chamber-side surface.

8. The piston according to claim 1, wherein the piston has at least one first acceleration edge between the combustion chamber-side surface and the at least one protrusion and at least one second acceleration edge between the at least one protrusion and the depression.

9. The piston according to claim 1, wherein the depression floor is formed to be less deep in a radial direction towards a center of the depression floor than in the radial direction towards an outer depression rim.

10. The piston according to claim 1, wherein the depression floor has an essentially conical region.

11. The piston according to claim 10, wherein the essentially conical region of the depression is arranged essentially concentrically to the depression.

12. The piston according to claim 1, wherein the piston has a piston skirt, which comprises a ring groove that is configured to accommodate a ring carrier with a piston ring, and wherein the at least one protrusion is delimited by the ring groove in the radial direction.

13. The piston according to claim 12, wherein the protrusion or a protrusion rim is arranged at a distance of at least 1 mm from the ring carrier of the ring groove.

14. The piston according to claim 1, wherein the shape of the at least one protrusion is essentially the shape of a circle segment.

15. The piston according to claim 1, wherein the internal combustion engine is a gas engine.

16. The piston according to claim 1, wherein the internal combustion engine is a compression-ignition engine.

17. The piston according to claim 1, wherein the ratio between the sum of all sections of the depression rim from which a protrusion extends and the entire depression rim is between 30% and 70%, between 40% and 60%, or between 45% and 55%.

18. The piston according to claim 1, wherein the ratio between one section of the depression rim from which a protrusion extends and the total depression rim is between 10% and 70%, between 15% and 50%, or between 20% and 30%.

19. The piston according to claim 1, wherein the at least one protrusion comprises a protrusion floor, wherein the protrusion floor or the edge between the depression rim and the at least one protrusion is tilted with respect to a plane substantially perpendicular to the axial direction of the piston at a tilt angle.

20. The piston according to claim 19, wherein the tilt angle is at least 3°, at least 5°, or between 4° and 20°.

21. The piston according to claim 19, wherein the piston comprises at least one first and one second protrusion and the tilt angle of the first protrusion is equal to the tilt angle of the second protrusion.

22. The piston according to claim 19, wherein the sign of the tilt angle is adapted to increase the swirl level in the combustion chamber.

23. The piston according to claim 2, wherein the majority of protrusions are distributed non-uniformly along the depression rim.
